(19) United States
(12) Patent Application Publication
(10) Pub. No.: US 2002/0167453 A1
(43) Pub. Date: Nov. 14, 2002

(54) High efficiency corrugated horn and flat top multiple beam antenna

(76) Inventors: Pamela H. Kung, Palo Alto, CA (US); Howard Ho-shou Luh, Sunnyvale, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 09/854,252

(22) Filed: May 11, 2001

(51) Int. Cl. H01Q 13/00

(52) U.S. Cl. 343/786; 343/781 R

(57) ABSTRACT

A broadband corrugated feed horn and flat top multiple beam antenna for use in satellite communication systems, and the like. The profile of corrugations of the horn is specially tuned or designed to flatten the aperture field distribution. As a result, the aperture efficiency increases, and the gain of the corrugated horn also increases. Also, the circular aperture and corrugated construction of the horn result in improved circular polarization characteristics. The flat top multiple beam antenna comprises an oversized reflector and a plurality of high efficiency feed horns that exhibit a flat top aperture field. The present high efficiency corrugated feed horns may be used in the flat top multiple beam antenna. The flat top multiple beam antenna has a reduced interference signal level, increased gain in the coverage area, and improved frequency reusability from a four-color to three-color configuration.

### BACKGROUND

The present invention relates generally to satellite communication systems. and more particularly, to a high efficiency broadband corrugated horn and flat top multiple beam antenna for use in satellite communication systems, and the like.

Prior art patents relating to corrugated horns include Japanese patent JP59185409A2 entitled “Corrugated Horn of Opening Surface Antenna” by Miyata Yoshihide et al., and European patent EP060922A1 entitled “Wide band Corrugated Horn” invented by Morz. Neither of these prior art designs provides high aperture efficiency. They typically employ HE11 mode (as is evident from the field strength versus radius plot of a conventional corrugated horn shown in FIG. 1). The aperture efficiency of these designs is about 70%.

Other previously known high aperture efficiency horns have designs that are different from that of the present invention. One is a rectangular (pyramidal) horn, which does not have a corrugated construction. This design is disclosed by M. Koerner and R. Rogers, in “Gain Enhancement of a Pyramidal Horn Using E and H-Plane Metal Baffles,” IEEE Trans. on Antennas and Propagation, Arpril 2000. Another is a conical horn having insertions, which is also not a corrugated construction. This design is disclosed by M. Clenet and L. Shafai, in “Gain enhancement of Conical horn by inserting bodies of revolution inside the Horn,” IEEE AP-S Symp.1998, page 1718.

Previously known multiple beam antennas use a paraboloidal reflector and a set of feed horns. Conventional feed horns used in multiple beam antennas include a Potter horn (used in a narrow band, system, and a conventional (HE11 mode) corrugated horn (used in a broadband system).

Previously known multiple beam antennas produce pencil beam radiation patterns as shown in FIG. 2. In order to maintain the crossover level between adjacent beams at −3 dB, the interference signal levels from co-frequency beams (i.e., beam 1 and 5) is quite high. As is shown in FIG. 2, the interference levels within beam 3 are −19.2 dB. Using a larger reflector can not solve this problem because a larger reflector causes a lower crossover level. This is the fundamental limitation of a multiple pencil beam antenna. The present invention provides a solution to this problem.

Therefore, it is an objective of the present invention to provide for a high efficiency broadband corrugated horn and flat top multiple beam antenna for use in satellite communication systems, and the like.

### SUMMARY OF THE INVENTION

The present invention provides for a high efficiency broadband corrugated horn and flat top multiple beam antenna for use in satellite communication systems, and the like. The corrugated horn exhibits high aperture efficiency, high gain, broadband operation, and high polarization purity. The corrugated horn is suitable for use in any multiple beam satellite communication system. Particularly, the corrugated horn is preferably used in a high performance Ka band multimedia satellite system that also employs the present flat top multiple beam antenna.

The profile of corrugations of the horn is specially tuned or designed to flatten the aperture field distribution (as shown in FIG. 3) compared to the conventional aperture field distribution (shown in FIG. 1). As a result, the aperture efficiency increases, and the gain of the corrugated horn also increases (compared to the horns disclosed in the Japanese and European patent, for example).

The circular aperture and corrugated construction of the corrugated horn result in better circular polarization characteristics than that of the pyramidal horns disclosed in the Koerner et al. reference, and the conical horn disclosed in the Clenet et al. reference.

The corrugated horn does not have metal baffles (as disclosed in the Koerner et al. reference) and/or inserted bodies (as disclosed in the Clenet et al. reference) disposed inside the horn. Consequently, the corrugated horn provides broad bandwidth operation.

The corrugated horn has high aperture efficiency (>80%) (versus 70% of the conventional corrugated horn), broadband capability (±6% bandwidth with respect to the band center), and low cross-polarization (<−40 dB) for all angles.

The present flat top multiple beam antenna comprises an oversized reflector and a plurality of high efficiency feed horns that exhibit a flat top aperture field. The present high efficiency corrugated feed horns, or dielectric loaded feed horns may be used in the antenna, for example. The flat top multiple beam antenna has a reduced interference signal level, increased gain in the coverage area, and improved frequency reusability (from a four-color to three-color configuration).

### BRIEF DESCRIPTION OF THE DRAWINGS

The various features and advantages of the present invention may be more readily understood with reference to the following detailed description taken in conjunction with the accompanying drawing figures, wherein like reference numerals designate like structural elements, and in which:

FIG. 1 is an apertual field strength versus radius plot of a conventional corrugated horn;

FIG. 2 illustrates a pencil beam radiation patterns produce by a conventional multiple beam antennas;

FIG. 3 is an apertual field strength versus radius plot of a corrugated horn in accordance with the principles of the present invention;

FIG. 4 is a cross sectional view of an exemplary corrugated horn in accordance with the principles of the present invention;

FIG. 5 the aperture field distribution of the exemplary corrugated horn shown in FIG. 4;

FIG. 6 illustrates co- and cross-circularly polarized radiation patterns produced by the exemplary corrugated horn shown in FIG. 4;

FIG. 7 illustrates the broadband behavior of the exemplary corrugated horn shown in FIG. 4;

FIG. 8 illustrates an exemplary flat top multiple beam antenna in accordance with the principles of the present invention; and

FIG. 9 illustrates the flat top radiation patterns produced by the exemplary flat top multiple beam antenna shown in FIG. 8.

### DETAILED DESCRIPTION

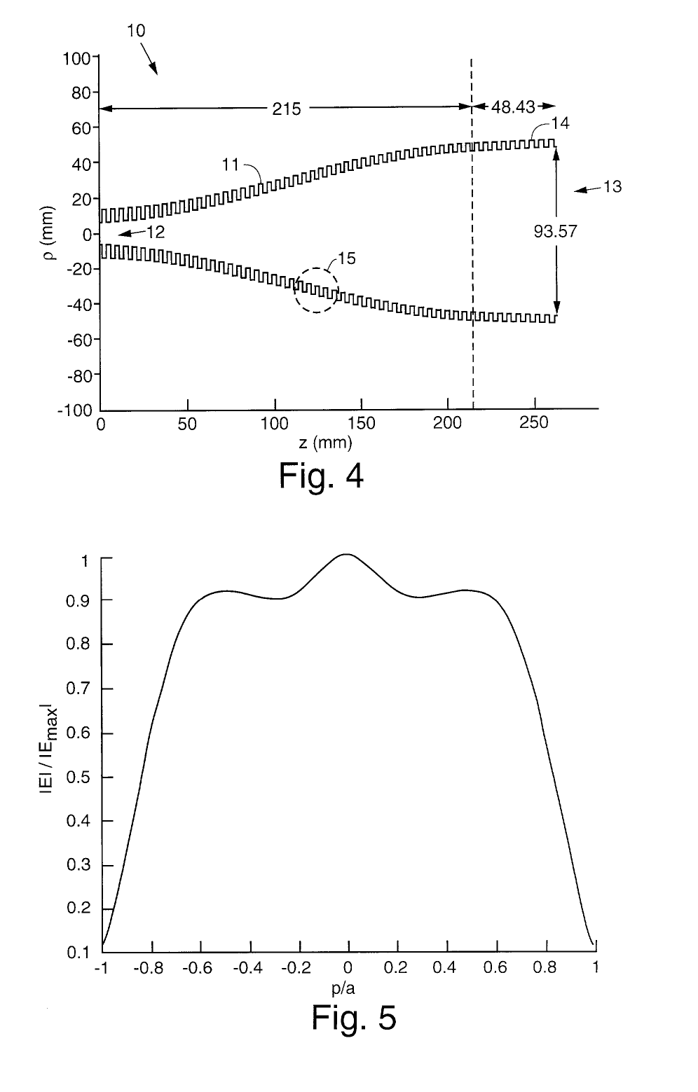

Referring to the drawing figures, FIG. 4 is a cross sectional view of an exemplary corrugated horn 10 in accordance with the principles of the present invention. FIG. 4 also illustrates the geometry of the exemplary corrugated horn 10.

The corrugated horn 10 comprises a tapered curvilinear body having a mode generating section 11 having an input aperture 12. The mode generating section 11 is coupled to a phase control section 14 disposed adjacent to an output aperture 13 of the corrugated horn 10. Both the mode generating section 11 and the phase control section 14 are comprised of a plurality of corrugations 15.

With proper profile design (using mathematical optimization), the mode generating section 11 generates a predetermined number of higher order HE1n modes. The phase control section 14 controls (also using mathematical optimization) the phase velocity of every mode that is generated by the mode generating section 11. By proper design, a high aperture efficiency (i.e., high gain), broadband and high polarization purity corrugated horn 10 is achieved. The design parameters are the profile of the horn 10, the length of the horn 10, the gloove width, the gloove separation and the slot depth of each corrugation 15.

The components of the exemplary corrugated horn 10 may have the following dimensions. The length of the mode generating section 11 may be 215 mm. The length of the phase control section 14 may be 48.43 mm. The corrugated horn 10 has a tapered cross section expanding from the input aperture 12 and expanding toward the output aperture 13. For example, the input aperture 12 may have an internal diameter of 12 mm. The corresponding internal diameter of the output aperture 13 may be 93.57 mm.

The gloove separation between the respective corrugations 15 is 5 mm. The respective slot depth of the corrugations 15 varies from 7.92 mm to 4.19 mm. The gloove width of the corrugation 15 varies from 2.505 mm to 3.361 mm.

The inside diameter of the taper is defined by the following equation:

(Please insert appropriate equation or definition, if possible)

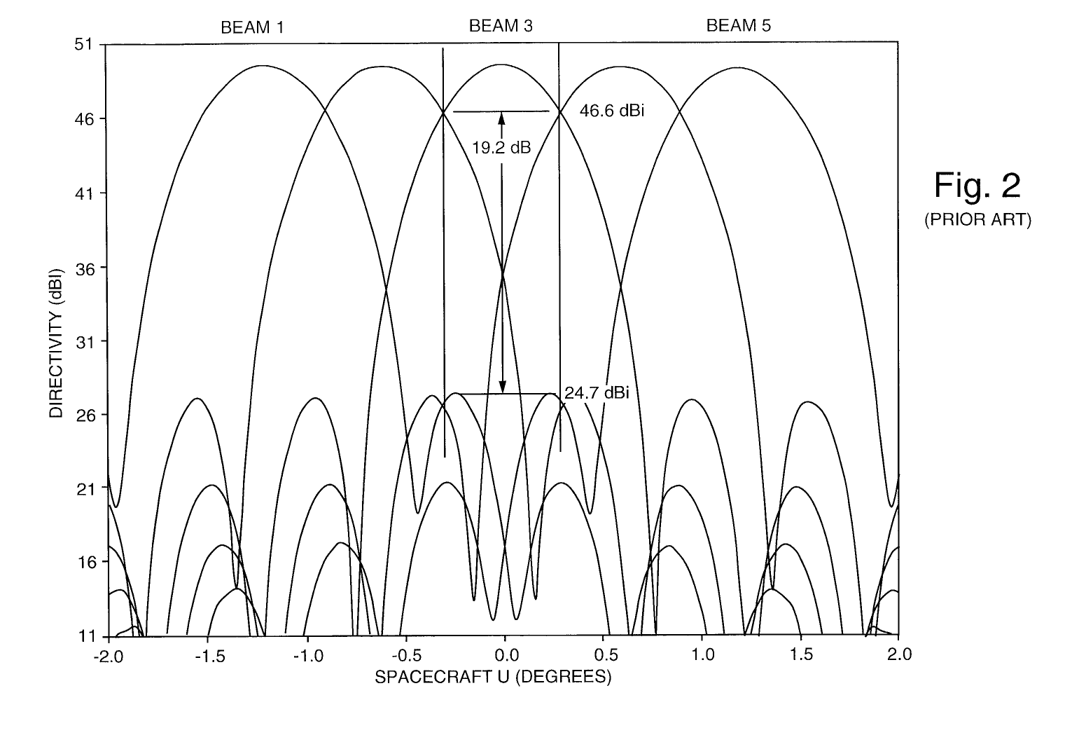

The profile of the corrugations 15 of the corrugated horn 10 is specially tuned (designed) to have a flattened aperture field distribution as shown in FIG. 2. As a result, the aperture efficiency increases, and the gain of the corrugated horn 10 also increases (compared with that of the horns disclosed in the above-referenced Japanese and European patents).

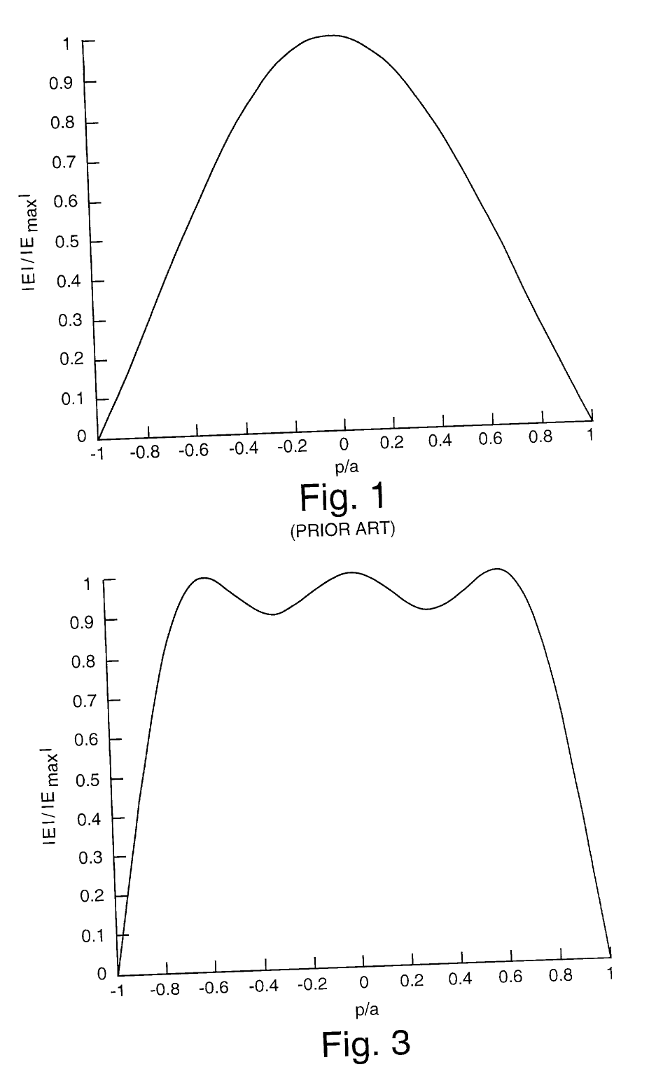

FIG. 5 shows the aperture field distribution of the exemplary horn 10. In comparison to the aperture field distribution of the conventional corrugated horn shown FIG. 1, the present horn 10 produces a substantially flatter aperture field distribution than the conventional corrugated.

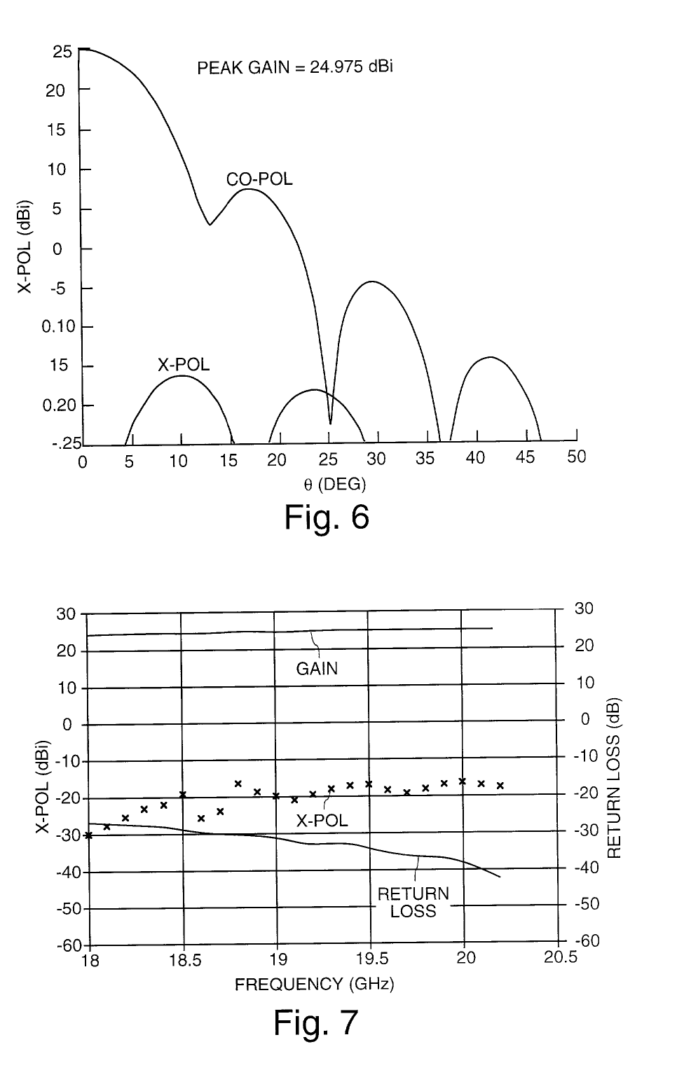

FIG. 6 illustrates the co-circularly polarized and the cross-circularly polarized radiation patterns of the exemplary corrugated horn 10. The peak gain of the corrugated horn 10 is 24.975 dBi at 20 GHz, which corresponds to an aperture efficiency of 81.8%. The cross-polarization level of the exemplary corrugated horn 10 is <−40 dB (=−16.0 dB plus −24.9 dB) below the peak of the co-polarization field.

FIG. 7 illustrates the broadband behavior of the exemplary corrugated horn 10. FIG. 7 show plots of cross-polarization (“x”), gain, and return loss for the exemplary corrugated horn 10.

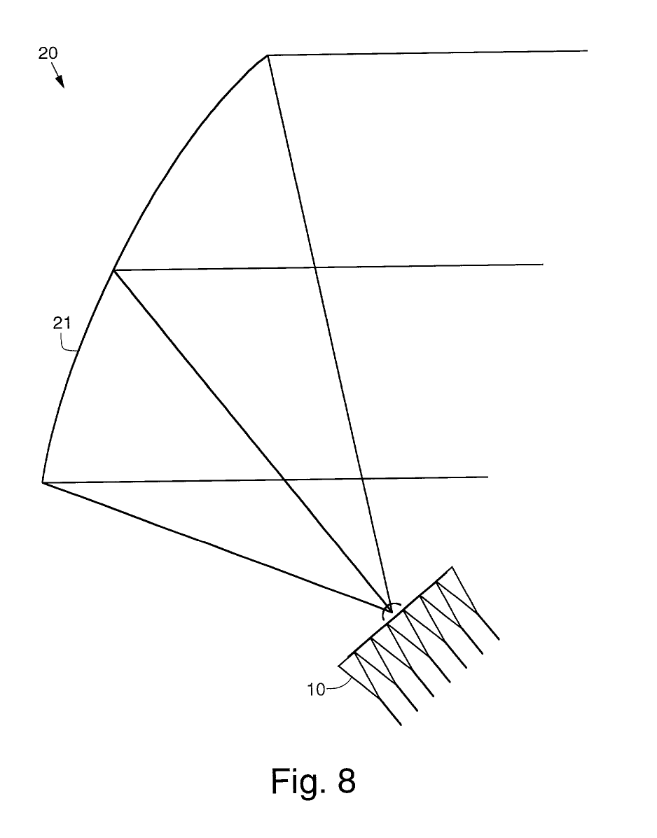

FIG. 8 illustrates the geometry of an exemplary flat top multiple beam antenna 20 in accordance with the principles of the present invention. The exemplary flat top multiple beam antenna 20 comprises an oversized parabolic reflector 21 that is fed using a plurality of high efficiency feed horns 10.

The diameter, D, of the oversized parabolic reflector 21 is greater than 100λ/θ_{C}, where λ is the wavelength of the radio frequency (RF) energy transmitted by the antenna 20, and θ_{C} is the diameter of coverage area of the antenna 20 in degrees. The diameter of the parabolic reflector 21 is oversized compared to the diameter (˜70λθ_{C}) of a reflector of a conventional pencil beam multiple beam antenna.

In addition, the high efficiency feed horns must exhibit a flat top aperture field, which may be achieved using a plurality of the above described high efficiency corrugated horns 10.

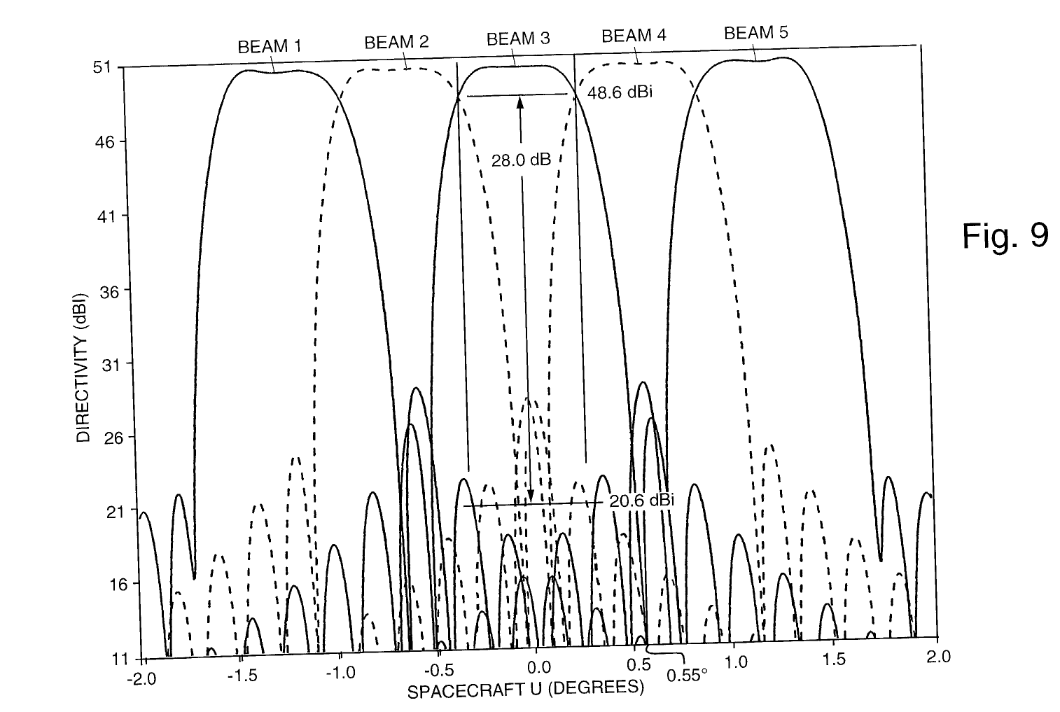

FIG. 9 illustrates the flat top radiation patterns produced by the exemplary flat top multiple beam antenna 20 shown in FIG. 8. FIG. 9 shows that the interference signal level has reduced to −28 dB (vs. −19 dB for the conventional antenna shown in FIG. 2), the edge of coverage (EOC) gain has increased from 46.6 dBi (FIG. 2) to 48.6 dBi, and the first null location has been reduced from 0.73 degrees (FIG. 3) to 0.55 degrees.

As a result, a communication system employing the flat top multiple beam antenna 20 can use a three-color frequency reuse arrangement instead of a four-color frequency reuse arrangement. Thus, the improvement in frequency reusability is 4/3 or. 30%.

Thus, high efficiency broadband corrugated horn and flat top multiple beam antenna for use in satellite communication systems, and the like have been disclosed. It is to be understood that the described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A feed horn comprising:
a circular tapered curvilinear body having a mode generating section and an input aperture, and a phase control section disposed adjacent to an output aperture, the tapered body having one or more walls comprising a plurality of corrugations having predetermine depths and widths, the mode generating section generating a predetermined number of higher order HE1n modes.

2. The feed horn recited in claim 1 wherein the phase control section controls the phase velocity of each mode that is generated by the mode generating section.

3. The feed horn recited in claim 2 wherein the corrugations comprise a profile is tuned to have a flattened aperture field distribution.

4. The feed horn recited in claim 1 which produces a substantially flat aperture field distribution.

5. A flat top multiple beam antenna comprising:
an oversized parabolic reflector; and
a plurality of high efficiency feed horns that exhibit a flat top aperture field and that couple energy to and from the oversized parabolic reflector.

6. The antenna recited in claim 5 wherein the diameter, D, of the oversized parabolic reflector is greater than 100λ/θ_{C}, where λ is the wavelength of radio frequency (RF) energy transmitted by the antenna, and θ_{C} is the diameter of coverage area of the antenna in degrees.

7. The antenna recited in claim 5 wherein the a plurality of high efficiency feed horns 10 comprise:
a plurality of corrugated horns that each comprise a circular tapered curvilinear body having a mode generating section and an input aperture, and a phase control section disposed adjacent to an output aperture, the tapered body having one or more walls comprising a plurality of having predetermine depths and widths, the mode generating section 11 generating a predetermined number of higher order HE1n modes.

8. The antenna recited in claim 7 wherein the phase control section controls the phase velocity of each mode that is generated by the mode generating section.

9. The antenna recited in claim 7 wherein the corrugations comprise a profile is tuned to have a flattened aperture field distribution.

10. The antenna recited in claim 7 wherein the feed horn produces a substantially flat aperture field distribution.
